(19) United States
(12) Patent Application Publication
(10) Pub. No.: US 2017/0161776 A1
(43) Pub. Date: Jun. 8, 2017

(54) METHOD FOR OPTIMIZING ADVERTISEMENT SPEND TO REACH ONLINE AUDIENCES FOR LONG TERM ENGAGEMENT

(71) Applicant: Google Inc., Mountain View, CA (US)

(72) Inventors: Ryo Akasaka, Zurich (CH); Thabet Alfishawi, San Francisco, CA (US)

(21) Appl. No.: 14/320,606

(22) Filed: Jun. 30, 2014

(51) Int. Cl. G06Q 30/02

(52) U.S. Cl. CPC G06Q 30/0246

(57) ABSTRACT

In a method and system for optimizing advertisement spend, it is determined that a user is to receive an advertisement campaign for a channel based on a target user action, a first advertisement of the advertisement campaign is presented on a user device of the user at a first time, and a second advertisement of the advertisement campaign is presented on the user device at a second time, wherein the second time is later than the first time. It is further determined whether the advertisement campaign was successful based on whether the target user interacted with the channel after presentation of the first advertisement and the second advertisement.

### TECHNICAL FIELD

Aspects of the present disclosure relate to the field of content sharing and, more particularly, to a method for optimizing advertisement spending to increase views of shared content.

### BACKGROUND

On the Internet, content sharing platforms can allow users to upload, view, and share digital content. Such digital content may include audio clips, movie clips, TV clips, and music videos, as well as amateur content such as video blogging, short original videos, pictures, photos, etc. Content can be organized into channels, where a channel can provide certain content on the channel (e.g., from a particular owner, source, organization, etc.).

As a way of generating revenue, advertisements can be associated with the content, where a viewer requesting the content views the advertisements upon requesting to view the content. An advertiser can pay a fee to have a certain advertisement be associated with certain content with the hope that a viewer of the advertisement and the content will be persuaded to respond in a certain way to the advertisement.

### SUMMARY

In some implementations, a method, implemented by a server computing system, includes: determining that a user requesting a first content item is to receive an advertisement campaign for a channel based on a user action, causing a first advertisement of the advertisement campaign to be presented to the user at a first time in association with the first content item, causing a second advertisement of the advertisement campaign to be presented to the user at a second time in association with a second content item, wherein the second time is later than the first time, and determining whether the advertisement campaign was successful based on whether the target user interacted with the channel after presentation of the first advertisement and the second advertisement.

In an implementation, the user action can include interacting with a related channel. The user action can be previous interaction with the channel.

In an implementation, the advertisement campaign can be determined to be successful upon determining that the target user has subscribed to the channel within a time period after presentation of the first advertisement or the second advertisement. The advertisement campaign can be determined to be successful upon determining that the target user has viewed the channel content a number of times within a time period after presentation of the first advertisement or the second advertisement. The advertisement campaign can be determined to be unsuccessful upon determining that the user has not interacted with the channel within a time period after presentation of the second advertisement.

In an implementation, the second advertisement can be an in-display advertisement. The first advertisement can be an in-stream advertisement.

In an implementation, the method can further include determining an advertisement fee based on presentation of the first advertisement and the second advertisement, and causing the fee to be assessed. The method can further include reporting whether the advertising campaign was successful.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with one embodiment of the present disclosure.

FIG. 2 illustrates an advertisement system, in accordance with one embodiment of the present disclosure.

FIG. 3 is a flow diagram illustrating one embodiment for a method of optimizing advertising.

FIG. 4A is an example user interface facilitating promotion of a channel.

FIG. 4B is an example user interface facilitating promotion of a channel.

FIG. 5 is a block diagram of an exemplary computer system that may perform one or more of the operations described herein.

### DETAILED DESCRIPTION

Aspects of the disclosure pertain to a method of optimizing advertising to promote a channel providing content, such as video or audio content, to a potential channel visitor via an advertisement associated with a content item. A channel can be an assemblage of data content available from a common source, or data content having a common topic, theme, or substance. Channel operators (e.g., channel owners or other channel curators) on a content sharing platform may want to attract a coherent audience of users that are more likely to keep watching content of the channel and that are more likely to subscribe to the channel. In addition, channel operators may want to increase a number of repeat visitors and subscribers, increase positive engagement with the channel (e.g., comments, likes, views, etc.), and to monetize their content (e.g., via fees for advertisements associated with content provided through the channel).

Aspects of the present disclosure assist channel operators in achieving the above goals by delivering advertisements for a channel (e.g., channel trailers) to users that are likely to interact with the channel based on previous user interactions or behavior. Additional advertisements can be subsequently delivered to retarget these users. The level of success of the advertisements for the channel can then be reported back to the channel operator. In some implementations, advertisers pay a fee for targeting a responsive audience of users, and the above report indicates the value of the advertisement money spent on the delivering of the advertisements.

In an implementation, a channel can be matched with audiences (e.g., users) that are likely to engage with that channel over the long term. For example, certain metrics, such as repeat visits to a channel over one or several weeks and explicit actions such as subscriptions, can correlate highly with repeated visits beyond a couple of weeks. Channel operators can increase (or boost) their channel's long term engagement via an advertisement campaign. Specific user lists can be used to lead audiences to a channel based on bids for advertisement placement. These bids can be defined by how much a channel operator is willing to spend to potentially get a long-term engaged user for that channel. The amount that the channel operator is willing to pay can factor into the advertisement placement auction system.

In an implementation, a channel operator can be asked for specific information to help create the advertising campaign, and to serve and optimize tailored delivering of advertisements to long term engaged users. For example, the channel operator can be asked to identify the channel to be promoted and the content (e.g., a video) that will be used to promote the channel. In an example, the content can be a portion or a summary of content that is available through the channel. A user list, e.g., a collection of anonymized users of a content sharing platform, can include users that have demonstrated a certain behavior, such as subscribing to a certain channel, commenting on a certain channel or certain content, liking a certain channel or certain content, watching a certain channel or certain content, or adding a certain channel or certain content to a playlist. Using signals that determine likelihood to engage in the future, users from the user list can be targeted with in-stream and/or in-display advertisements that promote channels of channel operators. In alternative implementations, various other types of advertisements and combinations of advertisements can be used to promote the channels.

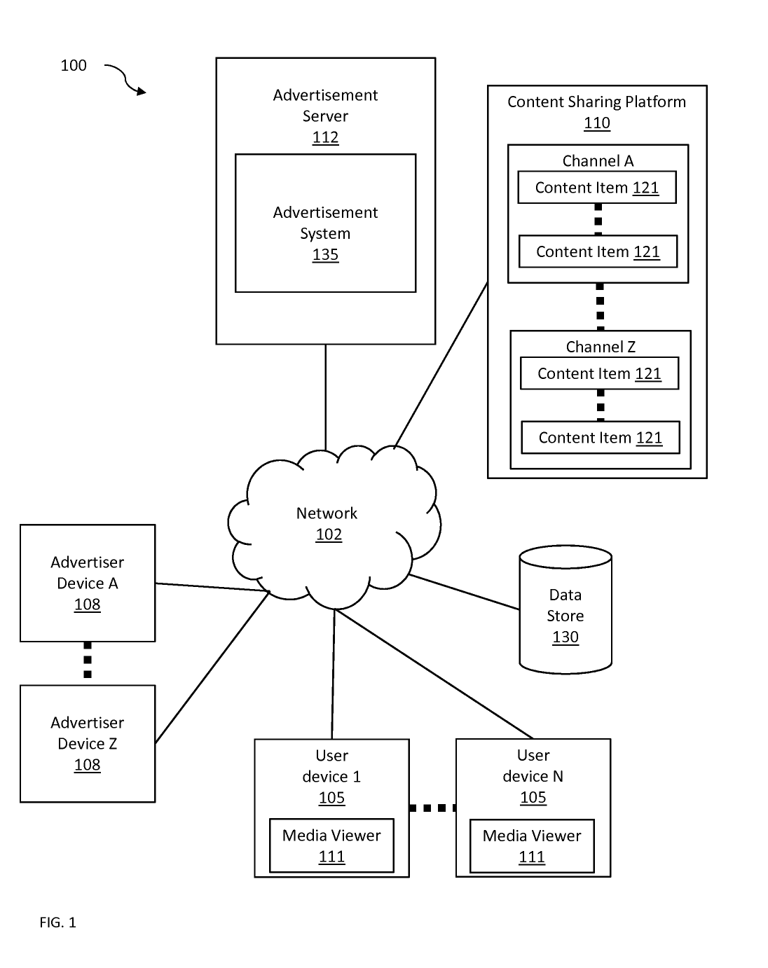

FIG. 1 illustrates exemplary system architecture 100, in accordance with one embodiment of the present disclosure. System 100 includes user devices 1-N 105, a content sharing platform 110, an advertisement management server 102, and an advertisement server 112, advertiser devices A-Z 108, and a data store 130 in communication with (e.g., coupled to) with each other over a network 102. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The user devices 1-N 105 may be any type of computing device, for example, a device including a processor, a computer-readable medium, and a memory. In some embodiments, the user devices 1-N 105 may be executing a browser application or other application adapted to communicate over Internet related protocols (e.g., TCP/IP and HTTP) and/or display a user interface. System 100 may support a large number of concurrent sessions with many client/user devices.

Each user device 1-N 105 can include a media viewer 111. In one implementation, the media viewers 111 may be applications that allow users to view content items, such as images, videos, web pages, documents, etc. For example, the media viewer 111 may be a web browser that can access, retrieve, present, and/or navigate content (e.g., web pages such as Hyper Text Markup Language (HTML) pages, digital media items, etc.) served by a web server. The media viewer 111 may render, display, and/or present the content (e.g., a web page, a media viewer) to a user. The media viewer 111 may also display an embedded media player (e.g., a Flash® player or an HTML5 player) that is embedded in a web page (e.g., a web page that may provide information about a product sold by an online merchant). In another example, the media viewer 111 may be a standalone application that allows users to view digital media items (e.g., digital videos, digital images, electronic books, etc.). The media viewers 111 may be provided to the user device 1-N 105 by the content sharing platform 110. For example, the media viewers 111 may be embedded media players that are embedded in web pages provided by the content sharing platform 110. In another example, the media viewers 111 may be applications that are downloaded from another server.

The content sharing platform 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

In one embodiment, the content sharing platform 110 provides content including content items (e.g., digital video, streaming video, images, digital music, streaming music, social media information, digital images, photographs, etc.) to the user devices 1-N 105. For example, the content sharing platform 110 may provide a media item, such as a streaming video, requested by a user for playback on the user device 1-N 105 via the network 102. The content sharing platform 110 may represent a video hosting website, a news content provider, a social network site, or any other entity that provides media content (e.g., video or audio content) to the user devices 1-N 105.

The content sharing platform 110 may include multiple channels (e.g., channels A through Z). A channel can be data content available from a common source or data content having a common topic or theme. The data content can be digital content chosen by a user, digital content made available by a user, digital content uploaded by a user, digital content chosen by a content provider, digital content chosen by a broadcaster, etc. For example, a channel X can include videos Y and Z. A channel can be associated with an owner or operator, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. Once a user subscribes to a channel, the user can be presented with information from the channel's activity feed. If a user subscribes to multiple channels, the activity feed for each channel to which the user is subscribed can be combined into a syndicated activity feed. Information from the syndicated activity feed can be presented to the user.

Each channel may include one or more content items 121. Examples of a content item 121 can include, and are not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. In some implementations, content item 121 is also referred to as a media item.

A content item 121 may be consumed via the Internet and/or via a mobile device application. For brevity and simplicity, an online video (also hereinafter referred to as a video) is used as an example of a content item 121 throughout this document. As used herein, “media,” media item,” “online media item,” “digital media,” “digital media item,” “content,” and “content item” can include an electronic file that can be executed or loaded using software, firmware or hardware configured to present the digital media item to an entity. In one implementation, the content sharing platform 110 may store the content items 121 using the data store 130.

Data store 130 can store media content or links to media content and can include one or more writable persistent storage devices, such as memories, tapes or disks. Although the content sharing platform 110 and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

During operation of system 100, a user requests a content item (e.g., video or audio content) via the user device 1-N 105 over network 102. The content sharing platform 110 receives the request, and responds to the request by providing the requested content item with one or more advertisements.

In some implementations, the content sharing platform 110 can determine what advertisement(s) to provide with the requested content item using the advertisement server 112. The advertisement server 112 can be an independent system and can include one or more computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Alternatively, the advertisement server 112 can be hosted by the same machine(s) as the content sharing platform 110.

In some implementations, advertisers can access the advertisement server 112 via advertiser devices A-Z 108 to enter, maintain and track advertisement information. The advertisement server 112 may provide a list of available advertisement placements and corresponding prices for the available placements to the advertisers. A placement may refer to any web or user interface (UI) property that can enable the presentation of advertisements. A web or UI property can represent, for example, a search result UI, a watch page UI, a website, a subset of web pages, or any other network distributed content, etc. An advertiser can specify one or more targeting criteria (e.g., type of content, type of UI, etc.) to select placements on which the advertiser would like to place the ads. The advertisement server 112 may then store the associations between the placements and the corresponding ads. The ads may include graphical ads (e.g., banner ads), text only ads, image ads, audio ads, video ads, etc. The ads may also include embedded information, such as a link, meta-information, and/or machine executable instructions.

The advertisement server 112 can provide the indicated advertisements via an advertisement system 135. In some implementations, the advertisement system 135 can obtain one or more advertisements to provide to the user device 105 for display, e.g., via the media viewer 111. In an implementation the advertisement server 112 and/or advertisement system 135 can be part of the content sharing platform 110.

The advertisement system 135 can obtain advertisements in response to an advertisement request of the content sharing platform 110 when it receives a content item request from the user device 1-N 105. The advertisement request may include content item request information such an identifier of the requested content item, a category corresponding to the requested content item (e.g., business, movies, music, etc.), content item type (e.g., video, audio, etc.), content item age, geo-location information, etc.

Upon receiving an advertisement request, the advertisement server 112 may select one or more ads matching the content item request information, and provide the selected ads to the content sharing platform 110 or directly to the user device 105.

In an implementation, the ads selected by the advertisement server 112 are auctioned to determine what ads should be returned to the content sharing platform 110 and/or the order in which they should be presented to the user. This determination may depend on, for example, other advertisers' bids (e.g., the maximum amount an advertiser will pay per user click on an advertisement) and/or the performance scores of the ads. The performance score of an ad may be calculated based on, for example, historical click-through rates, relevance of an advertiser's ad text and keywords, an advertiser's account history, etc. In another implementation, the ads are selected by the advertisement server 112 on a reservation basis (e.g., based on predefined conditions) without taking into account other advertisers' bids and/or the performance scores of the ads.

In an implementation, a channel owner or operator can use an advertiser device A-Z 108 to define an advertisement campaign for the channel. The advertisement campaign may identify a channel to be promoted and one or more advertisements (e.g., a channel trailer and/or screen capture/graphic) for promoting the channel to potential viewers. The advertisement campaign can also specify a fee (e.g., the fee that the channel operator is willing to pay) for targeting users that are likely to engage with the channel over a long period of time (long term engagement). Based on the advertisement campaign, the advertisement system 135 can determine a list of potential users for the channel, e.g., based on previous user activities. In one example, the list of users is determined based on past user interaction with that channel or content of that channel, and/or user interaction with similar channels or content similar to content provided by the channel. During an auction associated with a request for content item 121 from a user on the above list, the advertisement system 135 submits a bid for the advertisement promoting the channel in accordance with the fee specified by the channel operator.

Upon a bid of the channel operator being accepted or winning, an advertisement of the advertisement campaign is presented to the user on the list via a media viewer 111 on a user device 1-N 105 in association with the requested content item 121. In an example, a channel trailer (e.g., a portion or summary of video content from the channel) is displayed to the user prior to display of the content item requested by the user. A second advertisement of the advertisement campaign can be presented to the user at a second time to “retarget” the user. For example, a screen capture or other graphic could be displayed to the user alongside the requested content item when the requested content item is being watched by the user. In another example, retargeting can be done in association with a different content item requested by the same user. For example, the first advertisement or the second advertisement of the advertisement campaign can be presented to the same user when that user later submits a different request for a content item (e.g., the same or different content item). Whether the advertisement campaign was successful can be determined based on whether the target user interacted with the channel after presentation of the first advertisement and/or the second advertisement.

In situations in which the systems discussed herein collect personal information about users, or may make use of personal information, the users may be provided with an opportunity to control whether the content sharing platform 110 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 110

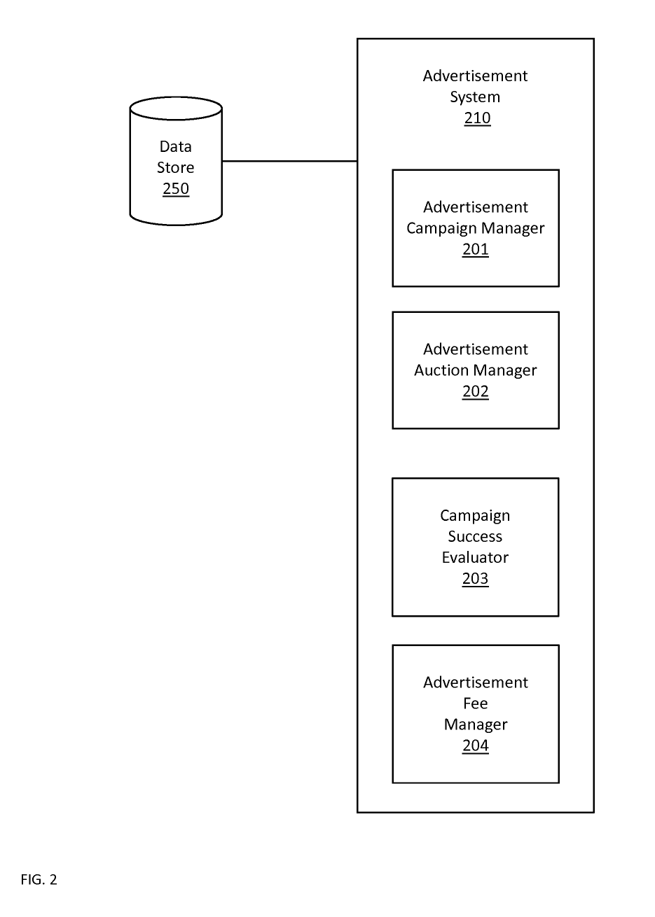

FIG. 2 illustrates an advertisement system 210, in accordance with one embodiment of the present disclosure. The advertisement system 210 may include an advertisement campaign manager 201, an advertisement auction manager 202, a campaign success evaluator 203, and an advertisement fee manager 204. More or less components may be included in the advertisement system 210 without loss of generality. In an embodiment, advertisement system 210 is advertisement system 135 and data store 250 is data store 130, which are shown in FIG. 1.

In an embodiment, the advertisement system 210 receives a request from a channel operator to define an advertisement campaign, with the goal of increasing traffic to the channel. The advertisement campaign manager 201 can then determine users to target for promoting the channel, e.g., based on previous user actions.

For example, a channel operator can submit one or more advertisements (e.g., channel trailers, content items, graphics, screen shots, etc.) for the channel that are to be targeted to potential viewers for the channel. The channel operator may also provide a bid (e.g., a certain monetary value) to win an advertisement placement for the one or more advertisements. The advertisement campaign manager 201 can then determine a list of users to target. In an implementation, the advertisement campaign manager 201 can determine the list based on activities of the users (e.g., previous activities of the users), such as content viewed, channels viewed, channels subscribed to, channels or content that are “liked”, channels or content that the user commented on, etc. In an example, the advertisement campaign manager 201 can include users on the list that have interacted with the channel previously, such as by viewing content on the channel. In some embodiments, the advertisement campaign may also specify different fees that the channel operator should be charged depending on whether the advertisement campaign is successful or not. For example, if the bid of the channel operator is accepted but a targeted user does not interact with the channel a certain number of times, the channel operator will be charged a smaller fee. Alternatively, if the bid of the channel operator is accepted and the target user interacts with the channel at least a certain number of times, the channel operator will be charged a larger fee.

In an embodiment, the advertisement auction manager 202 causes a bid for one of the advertisements to be submitted when a user on the list requests a content item (e.g., a content item having a topic or theme similar to the topic or theme associated with the channel). Upon a bid of the channel operator being accepted or winning, the advertisement can be provided to the user on the list with the requested content item that has an advertising placement associated with it. Further to this example, the advertisement can be presented to the user prior to the requested content item being displayed. Also, the advertisement can be displayed on a user's personal page, as a sidebar advertisement, or in any other suitable manner.

In an embodiment, the advertisement auction manager 202 can also cause another advertisement (e.g., a different or same advertisement to the first advertisement) to be presented to the user after a first advertisement has been presented. For example, the other advertisement can be displayed as an in-display or sidebar advertisement to “retarget” the user and increase the likelihood of the user choosing to interact with the channel.

In an embodiment, the campaign success evaluator 203 can determine the level of success of the advertisements or advertising campaign by determining whether the targeted user interacted with the channel (e.g., by viewing content, subscribing, liking, commenting, etc.) subsequent to the display of either of the advertisements. In an implementation, the campaign success evaluator 203 can determine that the advertisement or advertising campaign was a success in response to the targeted user interacting with the channel a certain number of times (e.g., one, two, three, etc.) within a certain number of time period or number of days (e.g., one day, one week, one month, etc.). The threshold number of times may vary depending on the nature of interaction. For example, for a channel subscription, a single occurrence may be sufficient while for viewing or endorsing (e.g., liking or commenting), a higher number of occurrences may be needed. If the user did interact with the channel a certain number of times within a certain time period, the advertising campaign is determined to be a success. If the target user does not interact with the channel a certain number of times within a certain number of days, then the advertising campaign is determined to not be a success. Whether the advertisement campaign was successful can then be reported to the channel operator.

In an embodiment, an advertisement fee manager 204 can calculate a fee that should be charged to the channel operator. For example, the fee can be based on whether the entire advertisement was shown or only a portion of the advertisement was shown, such that a smaller fee or no fee is charged. The fee can also be based on a position in the order of advertisements that the advertisement was shown (e.g., advertisements shown later in the order could have a higher or lower fee). The fee can also be based on whether the advertising campaign was successful or not.

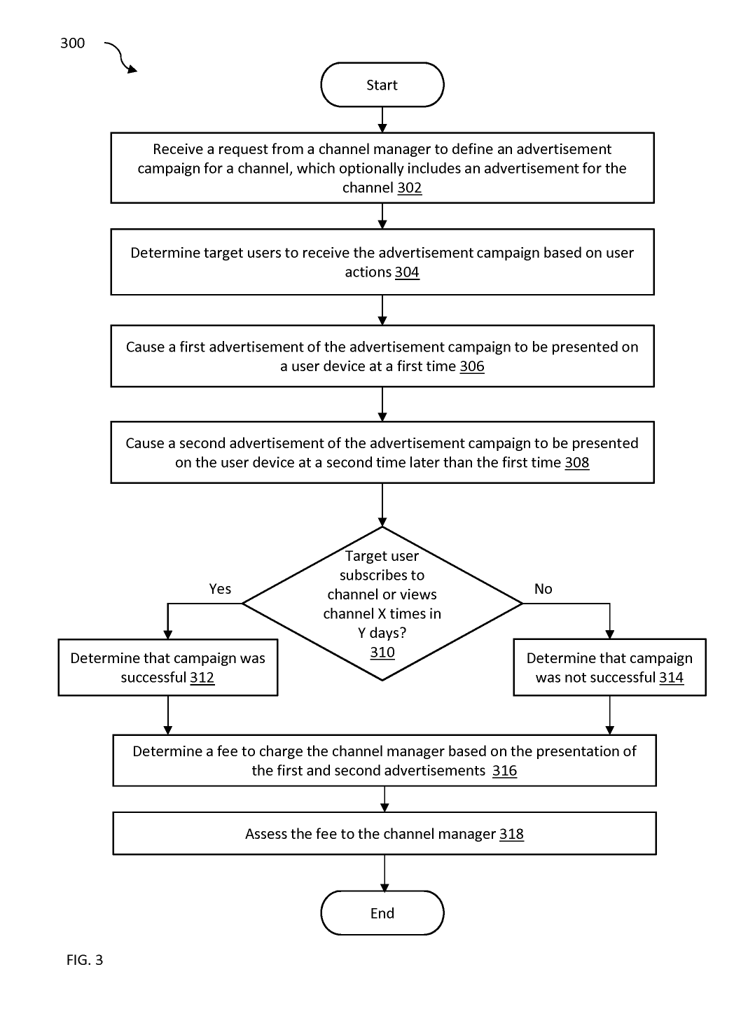

FIG. 3 is a flow diagram illustrating an embodiment for a method 300 of optimizing advertising. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by advertisement system 135 FIG. 1.

At block 302, processing logic receives a request from a channel operator or manager to define an advertisement campaign for a channel, which optionally includes an advertisement for the channel. In an example, the operator of Channel A requests that one or more target users be identified to receive an advertisement campaign to promote Channel A on Content Sharing Platform Y. The operator has the goal of increasing traffic to Channel A, such that advertising revenue earned from Channel A will increase. The operator also submits an in-stream advertisement, which is a popular content item available on Channel A, and an in-display advertisement (or sidebar advertisement) that shows a screen shot from the same popular content item. The operator also submits a successful bid for desired advertising placements, including displaying the in-stream advertisement prior to suitable requested content items and displaying the in-display advertisement alongside other content items that targeted users might view.

At block 304, processing logic determines target user(s) to receive the advertisement campaign based on user actions. Further to the example above, User A is determined to be a target user because User A has previously interacted with content items from Channel A.

At block 306, processing logic causes a first advertisement of the advertisement campaign to be presented on a user device at a first time. Further to the example above, User A requests that a content item be presented (a video be played) on User A's user device through Content Sharing Platform Y, which communicates with the advertisement system to obtain one or more advertisements to be presented with the requested content item. The advertisement system provides a first advertisement promoting Channel A. Prior to the content item being displayed, the in-stream advertisement for Channel A is displayed to User A to prompt User A to interact with Channel A. An in-stream advertisement refers to a sponsored content that appears in a media player with a featured content item (video). An in-stream advertisement can be skippable (the user can skip the playback of the advertisement and proceed to the featured video before the media player reaches the end of the advertisement) or non-skippable (the user cannot proceed to the featured video until the media player reaches the end of the advertisement). When a user initiates the playback of a featured video, an in-stream advertisement can appear prior to the playback of the featured video (pre-roll), at points during the playback of the featured video (mid-roll), or after the playback of the featured video (post-roll). In-stream advertisements can be presented, for example, in a desktop-based user interface, in a web browser (e.g., on a desktop or a mobile device), in a user interface of a mobile app, in a connected TV user interface, in a game console user interface, etc. At block 308, processing logic causes a second advertisement of the advertisement campaign to be presented on the user device at a second time later than the first time. Further to the example above, the next day User A is consuming other (or same) content on Content Sharing Platform Y, and the in-display advertisement is displayed alongside the other content to retarget User A to interact with Channel A. In alternative embodiments, the advertisement system provides the first advertisement and the second advertisement for presentation with the same content item initially requested by the user but at different times. For example, the first advertisement may be presented to the user before the playback of the content item and the second advertisement may be presented to the user during the playback of the content item.

In implementations, other number of advertisements can be provided to the targeted user as part of the advertising campaign. For example, three advertisements, four advertisements, five advertisements, etc., can be provided to the targeted user as part of the advertising campaign.

At block 310, processing logic determines whether the target user subscribes to channel or views channel a certain number of times in a certain number of days or a certain period of time (e.g., based on information provided by the content sharing platform). At block 312, processing logic determines that the campaign was successful, or, at block 314, processing logic determines that the campaign was not successful. Further to the example above, if the target user interacts with Channel A once within a week of the second advertisement, then the advertising campaign is considered successful. In this example, User A subscribes to Channel A on the day that the in-display advertisement was displayed to User A, so the advertising campaign is determined to be successful.

At block 316, processing logic determines a fee to charge the channel manager based on the presentation of the first and second advertisements. At block 318, processing logic assess the fee to the channel manager. Further to the example above, the operator of Channel A is assessed a fee for the advertising campaign that corresponds to the amount of the bid.

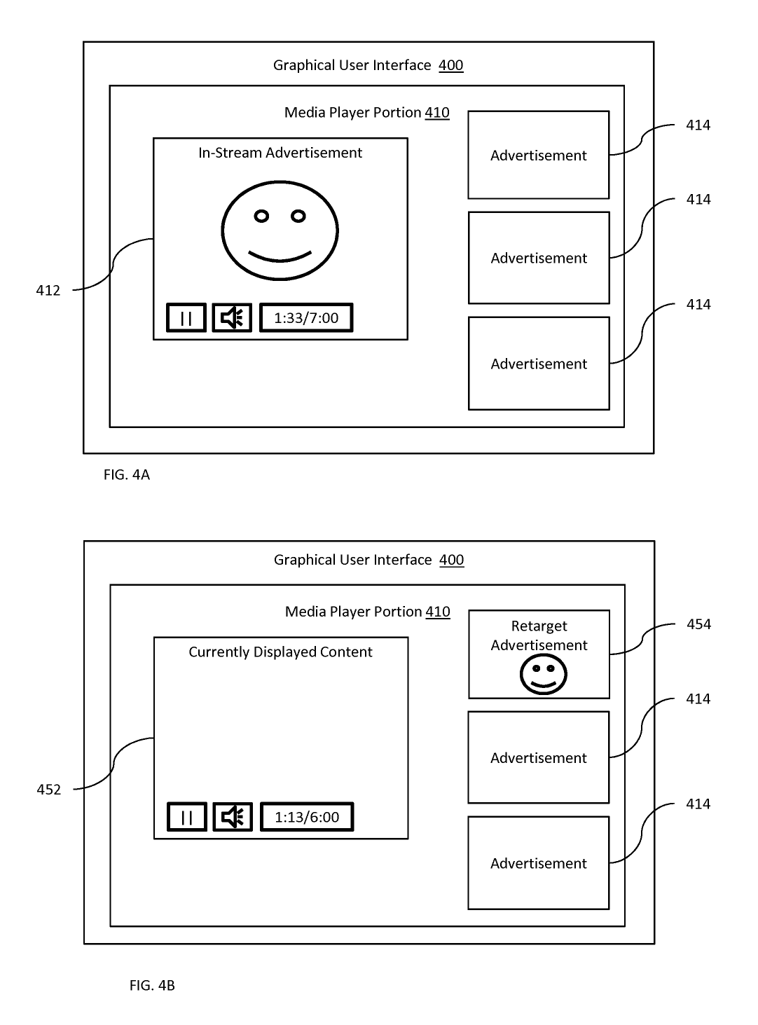

FIG. 4A illustrates an example graphical user interface 400 according to an embodiment (e.g., on a display of the user device 1-N 105 of FIG. 1), e.g., during display of a first advertisement of an advertising campaign. The graphical user interface 400 can include a media player portion 410. The media player portion 410 can display a content portion 412 where, in an embodiment, an in-stream advertisement can be presented prior to playing a content item. In an example, the in-stream advertisement can be a first advertisement of an advertising campaign for a channel, such as a channel trailer or a content item from that channel. Other advertisements 414, such as in-display or sidebar advertisements that include screen shots or other graphics can also be displayed in the media player portion 410.

FIG. 4B illustrates an example graphical user interface 400 according to an embodiment (e.g., on a display of the user device 1-N 105 of FIG. 1), e.g., during display of a second advertisement of an advertising campaign. The graphical user interface 400 can include a media player portion 410. The media player portion 410 can display a content portion 412 where a content item can be displayed. Other advertisements 414, such as in-display or sidebar advertisements that include screen shots or other graphics can also be displayed in the media player portion 410. In an embodiment, a second advertisement, e.g., a retarget advertisement 454, of an advertising campaign for a channel can be displayed as an in-display or sidebar advertisement.

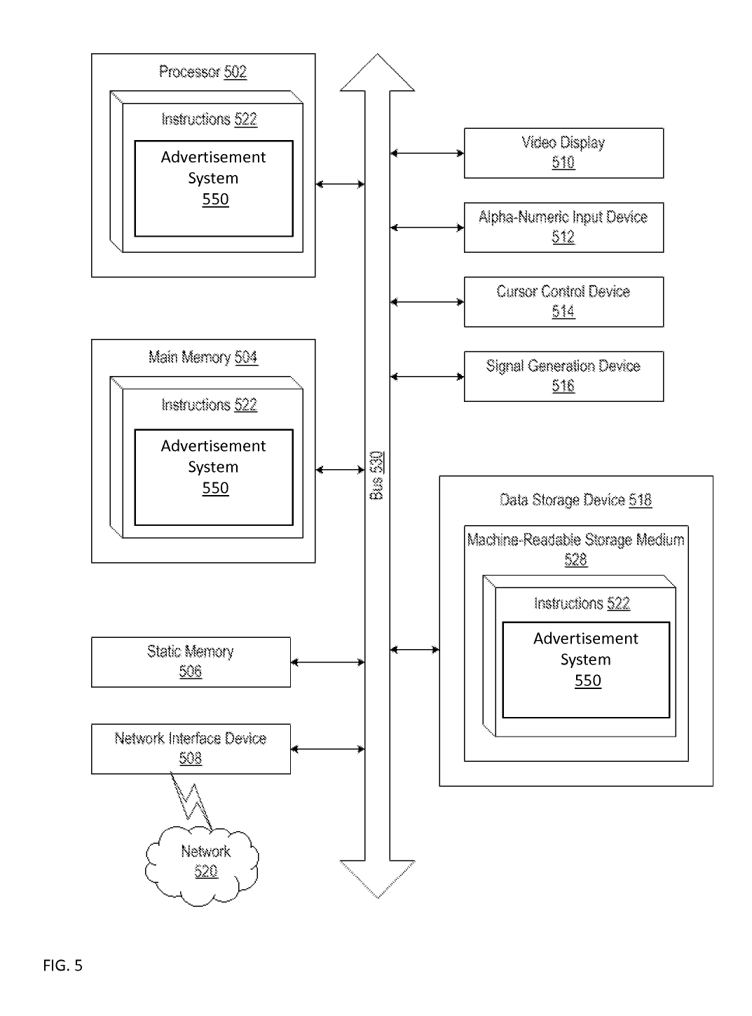

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-readable storage medium 528 (or computer-readable storage medium) on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 522 may further be transmitted or received over a network 516 via the network interface device 508.

In one embodiment, the instructions 522 include instructions for an skippable advertisement system 550, which may correspond to advertisement system 135 of FIG. 1, and/or a system for providing advertisements. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method, implemented by a server computing system, comprising:
determining, by a processing device of the server computing system, that a user requesting a first content item is to receive an advertisement campaign for a channel based on a user action;
causing, by the processing device of the server computing system, a first advertisement of the advertisement campaign to be presented to the user at a first time in association with the first content item;
causing, by the processing device of the server computing system, a second advertisement of the advertisement campaign to be presented to the user at a second time in association with a second content item, wherein the second time is later than the first time; and
determining, by the processing device of the server computing system, whether the first and second advertisements of the advertisement campaign are successful at increasing user engagement, wherein the first and second advertisements are determined to be successful in response to detecting a plurality of interactions of the user with the channel over a plurality of days, the plurality of days occurring after presentation of the first second advertisement.

2. The method of claim 1, wherein the user action comprises interacting with a related channel.

3. The method of claim 1, wherein the user action is previous interaction with the channel.

4. The method of claim 1, wherein the first and second advertisements are determined to be successful upon determining that the user has subscribed to the channel within a time period after presentation of the first advertisement or the second advertisement.

5. The method of claim 1, wherein the first and second advertisements are determined to be successful upon determining that the user has interacted with viewed the channel a threshold number of times within a time period comprising the plurality of days, wherein the threshold number of times varies depending on whether the interactions comprise a view, an endorsement, or a subscription.

6. The method of claim 1, wherein the first and second advertisements are determined to be unsuccessful upon determining that the user has not interacted with the channel within a time period comprising the plurality of days after presentation of the second advertisement.

7. The method of claim 1, wherein the first advertisement is an in-stream advertisement, and wherein the second advertisement is an in-display advertisement.

8. The method of claim 1, wherein the first content item and the second content item are the same or different content items.

9. The method of claim 1 further comprising:
determining an advertisement fee based on presentation of the first advertisement and the second advertisement; and
causing the advertisement fee to be assessed.

10. The method of claim 1 further comprising reporting whether the advertising campaign was successful.

11. A non-transitory computer readable storage medium having instructions that, when executed by a processing device, cause the processing device to perform operations comprising:
determining, by a server computing system, that a user is to receive an advertisement campaign for a channel based on a user action;
causing, by the server computing system, a first advertisement of the advertisement campaign to be presented on a user device at a first time;
causing, by the server computing system, a second advertisement of the advertisement campaign to be presented on the user device at a second time, wherein the second time is later than the first time; and
determining, by the server computing system, whether the first and second advertisements of the advertisement campaign are successful at increasing user engagement, wherein the first and second advertisements are determined to be successful in response to detecting a plurality of interactions of the user with the channel over a plurality of days, the plurality of days occurring after presentation of the second advertisement.

12. The non-transitory computer readable storage medium of claim 11, wherein the user action comprises interacting with a related channel.

13. The non-transitory computer readable storage medium of claim 11, wherein the user action is previous interaction with the channel.

14. The non-transitory computer readable storage medium of claim 11, wherein the first and second advertisements are determined to be successful upon determining that the user has subscribed to the channel within a time period after presentation of the first advertisement or the second advertisement.

15. The non-transitory computer readable storage medium of claim 11, wherein the first and second advertisements are determined to be successful upon determining that the user has viewed the channel a number of times within a time period after presentation of the first advertisement or the second advertisement.

16. The non-transitory computer readable storage medium of claim 11, wherein the first and second advertisements are determined to be unsuccessful upon determining that the user has not interacted with the channel within a time period comprising the plurality of days after presentation of the second advertisement.

17. The non-transitory computer readable storage medium of claim 11, wherein the first advertisement is an in-stream advertisement; and wherein the second advertisement is an in-display advertisement.

18. The non-transitory computer readable storage medium of claim 11, wherein the operations further comprise:
determining an advertisement fee based on presentation of the first advertisement and the second advertisement;
causing the advertisement fee to be assessed; and
reporting whether the advertising campaign was successful.

19. A system comprising:
a memory; and
a processing device coupled to the memory, wherein the processing device is configured to:
determine that a user is to receive an advertisement campaign for a channel based on a user action;
cause a first advertisement of the advertisement campaign to be presented on a user device of the user at a first time;
cause a second advertisement of the advertisement campaign to be presented on the user device at a second time, wherein the second time is later than the first time; and
determine whether the first and second advertisements of the advertisement campaign are successful at increasing user engagement, wherein the first and second advertisements are determined to be successful in response to detecting a plurality of interactions of the user with the channel over a plurality of days, the plurality of days occurring after presentation of the second advertisement.

20. The system of claim 19, wherein the user action comprises interacting with the channel or a related channel.

21. The system of claim 19, wherein the advertisement campaign is determined to be successful upon determining that the target user has subscribed to or viewed the channel within a time period after presentation of the first advertisement or the second advertisement.

22. The system of claim 19, wherein the first advertisement is an in-stream advertisement and the second advertisement is an in-display advertisement.

23. The system of claim 19, wherein the processing device is further to:
determine an advertisement fee based on presentation of the first advertisement and the second advertisement;
cause the advertisement fee to be assessed; and
report whether the advertising campaign was successful.
